(19) United States
(12) Patent Application Publication
(10) Pub. No.: US 2006/0044315 A1
(43) Pub. Date: Mar. 2, 2006

(54) Image processing apparatus and control method

(75) Inventor: Kunihiro Yamamoto, Kawasaki-shi (JP)

Correspondence Address: Canon U.S.A. Inc.;Intellectual Property Division, 15975 Alton Parkway, Irvine, CA, 92618-3731, US

(73) Assignee: Canon Kabushiki Kaisha, Ohta-ku (JP)

(21) Appl. No.: 11/202,496

(22) Filed: Aug. 12, 2005

(30) Foreign Application Priority Data
Aug. 30, 2004 (JP) 2004-250932

(51) Int. Cl. G06F 12/02; G09G 5/39; G09G 5/36

(52) U.S. Cl. 345/543; 345/557; 345/531

(57) ABSTRACT

In an image processing apparatus for reading out image data from a storage medium, performing predetermined processing on the image data, storing the image data in a storage unit and outputting the image data to an output unit, a control method for controlling a caching operation and an uncaching operation of the storage unit on the image data disclosed. In particular, types of image data stored in the storage medium are detected. If the detected types contain a predetermined type, the storage unit is controlled so as not to cache processed image data of any type other than the predetermined type.

### BACKGROUND OF THE INVENTION

1. Field of the Invention

The present invention relates to an information processing apparatus, which is generally called now as a personal computer (hereinafter referred to as a “PC”), used so as to operate as an image processing apparatus. In particular, the invention relates to an image processing apparatus which caches images processed in the image processing apparatus, and to a control method thereof.

2. Description of the Related Art

When managing images taken with an image capture apparatus such as a digital camera, a user generally uses an image processing application program running on a PC.

Conventionally, when plural images are displayed while being switched one after another in accordance with the instruction of a user, image data are read out prior to the instruction of the user, or images which have been previously used are cached so that responsiveness to the instruction of the user can be improved.

In the latter method, images which have been previously used are held in a cache memory, and if image data of an image which the user gives an instruction to display is left in the cache memory, the image data is read out from the cache memory. If the cache memory is full of images, an image which is determined to have a lower possibility to receive an instruction to display it again than the others is deleted from the cache memory according to a predetermined condition.

However, since the size of image data is generally large, there arises a problem that a satisfactory responsiveness cannot be obtained using a conventional cache algorithm.

To solve this problem, a method has been proposed in which in a case where font data and bitmap data obtained by rasterizing the font data are cached, the bitmap data is preferentially cached out in order to improve the efficiency of use of a cache (for example, Japanese Patent Application Laid-Open No. 8-263044).

The method disclosed in Japanese Patent Application Laid-Open No. 8-263044 is an effective technique in a case where a piece of data has a plurality of modes of image format like a font image. However, the above method cannot be applied to handling images taken with an image capture apparatus such as a digital camera.

### SUMMARY OF THE INVENTION

The present invention has been made in view of the above problem. For example, the present invention is effective when a plurality of images taken with an image capture apparatus such as a digital camera are read from a storage device and are output while being switched one after another. In particular, the efficiency of use of a cache memory can be increased and outputs can be switched with a satisfactory responsiveness.

In one aspect of the present invention, an image processing apparatus is, for example, configured as described below. That is, an image processing apparatus for reading out image data from a storage medium, performing decoding processing and predetermined image processing on the image data, storing the processed image data in a storage unit and outputting the processed image data to an output unit, includes a cache control unit configured to control a caching operation and an uncaching operation of the storage unit on the processed image data, and a detection unit configured to detect types of image data stored in the storage medium, wherein, if the types detected by the detection unit contain a predetermined type, the cache control unit controls the storage unit not to cache processed image data of any type other than the predetermined type.

In another aspect of the present invention, a control method for an image processing apparatus for reading out image data from a storage medium, performing decoding processing and predetermined processing on the image data, storing the processed image data in a storage unit and outputting the processed image data to an output unit, includes a cache control step of controlling a caching operation and an uncaching operation of the storage unit on the processed image data, and a detection step of detecting types of image data stored in the storage medium, wherein, if the types detected by the detection step contain a predetermined type, the cache control step includes a step of controlling the storage unit not to cache processed image data of any type other than the predetermined type.

Further features of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing a basic configuration of an image processing apparatus in accordance with a first embodiment.

FIG. 2 illustrates an example of a structure of a screen on the image processing apparatus in accordance with the first embodiment.

FIG. 3 is a diagram illustrating an example of a list of object images to be processed in accordance with the first embodiment.

FIG. 4 is a diagram showing an example arrangement of color filters in accordance with the first embodiment.

FIG. 5 is a flow chart showing processing steps to cache images in accordance with the first embodiment.

FIG. 6 is a flow chart showing processing steps to tidy up a cache memory in accordance with a second embodiment.

FIG. 7 is a flow chart showing processing steps to tidy up a cache memory in accordance with the second embodiment.

FIG. 8 is a flow chart showing processing steps to tidy up a cache memory in accordance with a third embodiment.

FIG. 9 is a flow chart showing processing steps of measuring time taken to perform decoding and image processing in accordance with the third embodiment.

FIG. 10 is a flow chart illustrating processing steps using a cache memory.

FIG. 11 is a flow chart illustrating a tidy-up method for the cache memory.

### DETAILED DESCRIPTION OF THE EMBODIMENTS

Exemplary embodiments of the invention will be described in detail below with reference to the drawings.

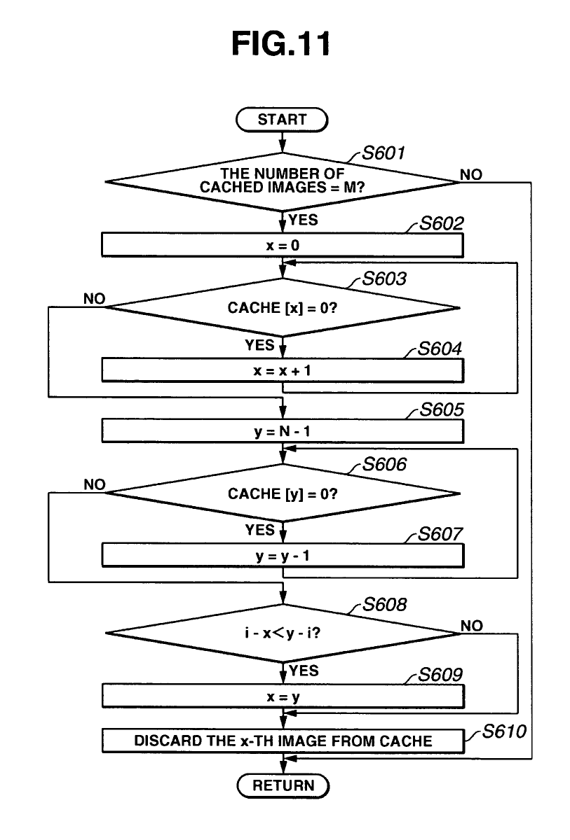

First of all, referring to FIG. 10 and FIG. 11, an image switching process using an ordinary cache memory will be described.

First, in step S401, when an instruction to display the i-th image is received responsive to the operation of an input device such as a keyboard or a mouse by a user, in step S402, a cache memory is checked to determine whether the i-th image is present therein. Here, values stored in an array CACHE in step S407 which will be described later are referred to so as to determine whether the element CACHE[i] corresponding to the i-th image is 0.

If the element CACHE[i] is not 0, since the image is already cached (yes in step S402), referring to an address held in the element CACHE[i], the process proceeds to step S403. In step S403, image data stored in the address held in the element CACHE[i] is displayed, and the process is then terminated.

On the other hand, if the element CACHE[i] is 0, since the image is not yet cached, the process proceeds to step S404. In step S404, the i-th image data is read out from a storage device (not shown), and is subjected to predetermined processing such as decoding. Then, the processed image data is stored in the cache memory. In step S405, the decoded image is displayed.

Next, in step S406, image data stored in the cache memory are tidied up. Generally, since the storage capacity of the cache memory is limited, in many cases, all of the images subjected to processing such as decoding cannot be cached. Therefore, caching of image data having a low possibility of being reused is released so that new image data can be cached. A particular tidy-up method will be described later.

In step S407, the address of the image data displayed in step S405 is stored in the i-th element, i.e., CACHE[i] of the array CACHE. The array CACHE is previously initialized with 0, and, in step S402, is used for determining whether the image is present in the cache memory.

In the above-described processing, if each image data is once subjected to processing such as decoding when being displayed first, the cached image, which has already been processed, can be reused when the same image is displayed for the second time or later. Thus, the image can be displayed at a high speed.

Next, the tidy-up method for cached data, which is carried out in step S406, will be described in detail with reference to a flowchart of FIG. 11.

Since, as described above, the capacity of the cache memory is limited, the number of cacheable images is limited. Therefore, in a case where a maximum of M images can be cached, when a number larger than M of images are to be cached, caching of image data having a low possibility of being reused is released. As for the method for determining image data having a low possibility of being reused, conventionally, several methods have been proposed. Here, it is presumed that an image having an image index close to that of the currently displayed i-th image has a high possibility of being reused, and an image having an image index far from that of the currently displayed i-th image has a low possibility of being reused.

First, instep S601, it is determined whether the number of already cached images is equal to M. If the number of already cached images is smaller than M, it indicates that the cache memory still has free space. Therefore, since any cached image does not have to be discarded, the process is terminated. On the other hand, if the number of already cached images is equal to M, the process proceeds to step S602. As shown in FIG. 10, in step S406, since the cache is always tidied up immediately before a new image is cached in step S407, the number of already cached images never exceeds M.

In step S602, a parameter x is initialized to 0. In step S603, it is determined whether an element CACHE[x] is 0. If the element CACHE[x] is 0, the process proceeds to step S604, where the parameter x is incremented by one. Then, the process returns to step S603, where it is determined again whether the element CACHE[x] is 0. In this way, the processes from step S603 and S604 are repeated until it is determined that the element CACHE[x] is not 0.

If, in step S603, it is determined that the element CACHE[x] is not 0, the process proceeds to step S605, where a parameter y is initialized with a value of N−1. N indicates the number of images stored in the storage device. Here, since the address holding area of the first image is set as an element CACHE[0], an initialization value of y is defined as N−1.

In step S606, it is determined whether the element CACHE[y] is 0. If the element CACHE[y] is 0, the process proceeds to step S607. In step S607, the parameter y is decremented by one. Then, the process returns to step S606, where it is determined again whether the element CACHE[y] is 0. In the same manner, the processes from step S606 to S607 are repeated until it is determined that the element CACHE[y] is not 0.

If, in step S606, it is determined that the element CACHE[y] is not 0, the process proceeds to step S608. In step S608, values i-x and y-i are compared with each other. If the value i-x is smaller than the value i-y (YES in step S608), the process proceeds to step S609. If not so (NO in step S608), the process proceeds to step S610.

In step S609, the parameter y is substituted for the parameter x. In step S610, the x-th image is discarded from the cache memory (memory is released), and the element CACHE[x] is substituted with 0.

According to the above process, when the cache memory is full, an image farthest from the currently displayed image can be discarded from the cache memory.

### First Embodiment

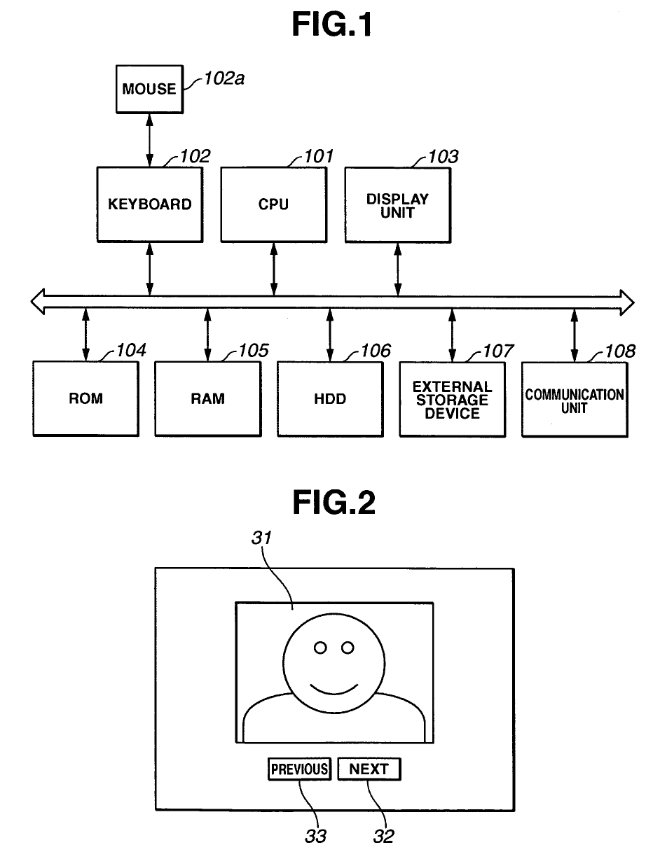

FIG. 1 is a block diagram showing a configuration of an image processing apparatus such as a computer system in accordance with the first embodiment of the invention.

In FIG. 1, a central processing unit (CPU) 101 controls the entire system. An input unit includes a keyboard 102 together with a pointing device 102a such as a mouse (hereinafter referred to as a mouse 102a). A display unit 103 is constructed from a cathode-ray tube (CRT) or a liquid crystal display (LCD).

The image processing apparatus shown in FIG. 1 includes a read-only memory (ROM) 104 and a random-access memory (RAM) 105. The ROM 104 and the RAM 105 constitute a storage device of the system and store programs to be executed by the system and data to be used by the system. The RAM 105 is used as a cache memory in the first embodiment.

The image processing apparatus shown in FIG. 1 further includes a hard disk drive (HDD) 106 and an external storage device 107 which is used for driving various kinds of detachable external storage media such as a floppy disk, a compact disk-read-only memory (CD-ROM), and a CompactFlash memory®. The external storage device 107 can drive an external storage medium usable in an image capture apparatus such as a digital camera or a digital video camera and can read out image data from the storage medium.

A communication unit 108 is used for connecting the image processing apparatus to a network such as an intranet or the Internet. The communication unit 108 may employ a wired or wireless system or may employ both systems. Image data input via the communication unit 108 can be stored in the HDD 106 or can be stored in the external storage medium via the external storage device 107.

FIG. 2 shows an example of a configuration of a screen by application software displayed on the display unit 103. The exemplary screen shown in FIG. 2 includes an image display area 31, a page forward (next) button 32, and a page backward (previous) button 33.

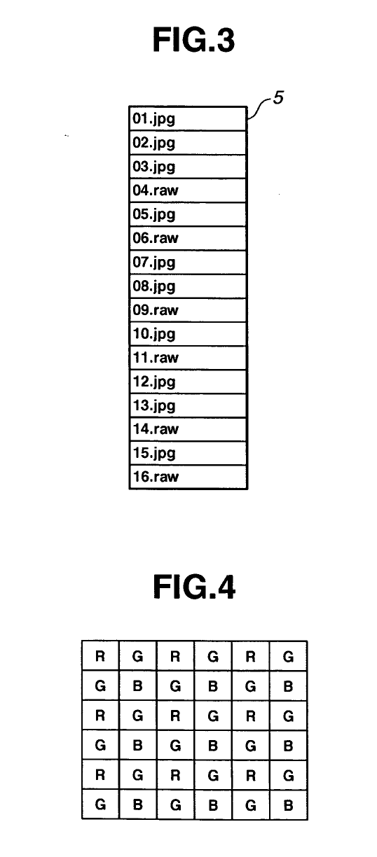

Here, it is presumed that N images are stored in the HDD 106 and/or an external storage medium mounted on the external storage device 107. FIG. 3 shows a list 5 of the stored images. In an example shown in FIG. 3, the list 5 indicates that 16 images are stored (N=16).

Based on a default value in the application software or an instruction given by a user, the i-th image in the list 5 is read out from the HDD 106 and/or the external storage device 107. The read image is subjected to decoding and image processing and is then displayed in the image display area 31. When the user presses the page forward button 32 via the mouse 102a, the next image, which is the i+1-th image in the list 5, is read out. When the user presses the page backward button 33, the i−1-th image in the list 5 is readout. The read image is subjected to decoding and image processing by the CPU 101 and is then displayed on the image display area 31.

In the list 5 shown in FIG. 3, data with an extension of “.jpg” are Joint Photographic Experts Group (JPEG) type image data. Since JPEG type image data are compressed data, the amount of data is relatively small. Also, since the amount of processing required for decoding and image processing after decoding is small, reading, decoding, and displaying of an image can be processed at a high speed.

On the other hand, data with an extension of “.raw” are RAW type image data, which are obtained by taking images using an image capture apparatus such as a digital still camera (hereinafter, the image capture apparatus is referred to as the “digital still camera”).

Generally, the digital still camera performs various image processing on RAW data. RAW data is digital data obtained by converting an electrical signal of a taken image obtained by performing photoelectric conversion on an optical image of an object by an image sensor, such as a complementary metal-oxide semiconductor (CMOS) or charge-coupled device (CCD) sensor.

To capture a color image, generally, the image sensor is covered with, for example, an array of color filters as shown in FIG. 4. Corresponding to each color of the color filters, each pixel outputs a signal (RAW data) having color information on the color.

RAW data obtained as described above is subjected to various processing, such as color correction, gamma correction processing, and white balance adjustment processing, and based on the processed data, an image to be output by an image output apparatus is reconstructed.

Hereinafter, the above processing is referred to as the image reconstruction process. The filter array shown in FIG. 4 is called the Bayer array, which is an array of R, G, and B filters repeatedly disposed with a set of R (red), and G (green) filters and a set of G and B (blue) filters on every other line. Since each pixel has only one color information, in the color interpolation in the Bayer array, the other color information is interpolated based on the color information of the neighboring pixels.

Generally, the above-described image reconstruction process is carried out within the digital still camera, and the processed image data is output. However, there is a case in which RAW data is directly recorded on a recording medium without carrying out the image reconstruction process, and the image reconstruction process is carried out using a personal computer or the like. For this purpose, using an extension of “.raw,” RAW data is distinguished from the other type image data, such as JPEG data. Compared to JPEG type image data, RAW type image data has the following characteristics. Even when the number of the pixels is the same, RAW type image data has a larger amount of data and, in addition, necessitates the image reconstruction process. Therefore, RAW type image data requires a longer period of time from read-out to displaying of an image.

In the list 5 shown in FIG. 3, files are arranged in the order of file names. However, the arrangement order of files is not limited thereto. For example, files may be arbitrarily arranged in the order of photographing date and time or data size.

Next, processing operation of the image processing apparatus configured as described above in accordance with the first embodiment will be described below.

In an application program for displaying images while switching them one after another as described above, there exists a time lag from a point of time when the user has pressed the page forward (next) button 32 or page back (previous) button 33 to a point of time when an image is actually displayed. This time lag includes mainly a period of time required for reading out data from the HDD 106 and/or the external storage medium and carrying out decoding and image processing by the CPU 101. In order to increase operational responsiveness by reducing the time lag, caching of image data is performed.

In the first embodiment of the invention, the image display method using the RAM 105 as a cache memory and the basic tidy-up method for the cache memory are the same as those described while reference to FIG. 10 and FIG. 11. Therefore, the description thereof is omitted. However, since the first embodiment is characterized in the caching method for an image at step S407 in FIG. 10, the description thereof will be given below.

If all of the images in the list 5 have substantially the same characteristics with respect to:
(1) the data size of each image stored in the HDD 106 and/or the external storage medium;
(2) the period of time required for reading out a file and carrying out decoding and image processing on the file; and
(3) the size of image data subjected to decoding and image processing and stored in the RAM,
a responsiveness can be increased by unconditionally carrying out caching in response to a cache request. This is a method generally carried out conventionally.

On the other hand, the first embodiment handles such a case that JPEG images and RAW images are mixed as shown in the list 5.

In this case, particularly, the period of time required for decoding and image processing in the above varies largely. For example, decoding and image processing of a RAW image occasionally requires a period of time several times longer than decoding and image processing of a JPEG image.

In such a case, if every image is handled uniformly as in a conventional manner, the efficiency of use of a cache decreases. In particular, since decoding processing of a JPEG image is carried out at a relatively high speed, a responsiveness is increased only a little even in the case of a cache hit, and a penalty in the case of a cache miss is small. However, since decoding and image processing of a RAW image is carried out at a relatively extremely slow speed, a responsiveness is sharply increased in the case of a cache hit, and a penalty in the case of a cache miss is large.

In view of the above conditions, in the first embodiment, if both a JPEG image and a RAW image are contained together, the JPEG image is not cached, but only the RAW image is cached.

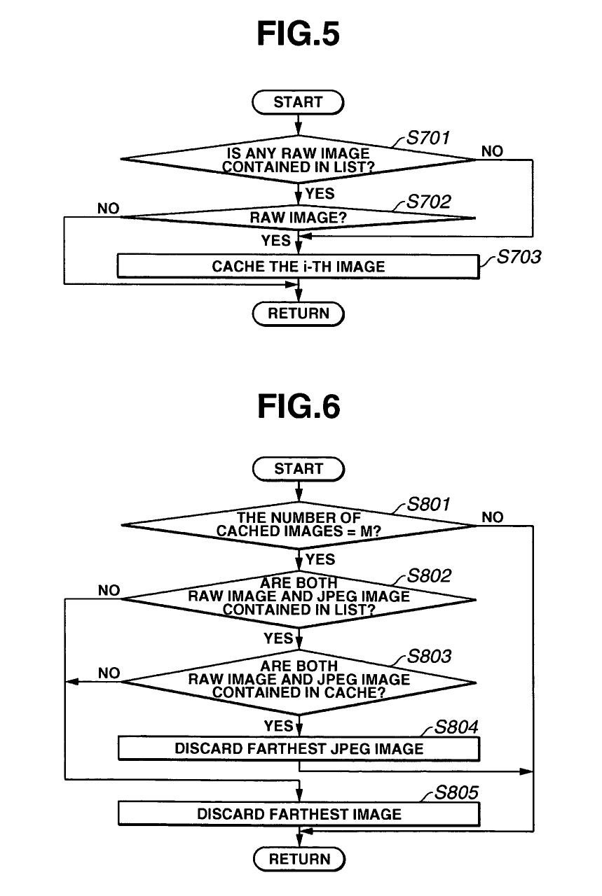

Referring to a flow chart of FIG. 5, steps of such a process will be described.

In step S701, it is determined whether any RAW image is contained in the list 5. If the list 5 contains only JPEG images and contains no RAW image, the process proceeds to step S703. In step S703, the i-th image (JPEG image) is cached, and the process is then terminated. That is, in this case, since all images are of a uniform type, caching is carried out unconditionally.

On the other hand, if one or more RAW images are contained in the list 5, the process proceeds to step S702. In step S702, it is determined whether the i-th image is a RAW image. If the i-th image is a RAW image, the process proceeds to step S703. Instep S703, the i-th image (RAW image) is cached, and the process is then terminated. If, in step S702, the i-th image is a JPEG image, the i-th image is not cached, and the process is then terminated.

As described above, according to the first embodiment, if both a JPEG image and a RAW image are contained together, the RAW image can be efficiently cached without being interfered by the JPEG image. If no RAW image is contained, even a JPEG image is cached. Thus, the total operation responsiveness can be increased.

In the above-described first embodiment, a caching operation in the case where two types of images, i.e., a RAW image and a JPEG image, are contained together has been described. However, the invention is not limited to the case where two types are contained. Needless to say, the invention is applicable to the case where three or more types are contained. In this case also, if any RAW image is contained, using the processing steps shown in FIG. 5, a caching operation can be controlled based on whether a RAW image is contained or not, i.e., can be controlled according to whether the object image is a RAW image or another type of image. Alternatively, among various types of images, a type of image of which a period of time required for decoding and image processing is longer may be given a higher order of priority. In this case, if one or more types of image data with a higher order of priority are contained, a caching operation is controlled such that a type of image data with a lower order of priority is not cached. Thus, the same advantageous effect can be obtained.

### Second Embodiment

Next, processing in an image processing apparatus configured as described above in accordance with a second embodiment of the invention will be described.

Since an image display method using the RAM 105 as a cache memory in accordance with the second embodiment is similar to the method described with reference to FIG. 10, the description thereof will be omitted. However, the basic tidy-up method for a cache memory carried out in step S406 shown in FIG. 10 is different from the method shown in FIG. 11. Accordingly, with reference to a flowchart in FIG. 6, the tidy-up method for a cache memory in accordance with the second embodiment will be described in detail below.

In the second embodiment, unlike the first embodiment, processing for caching only a RAW image as described with reference to FIG. 5 is not performed, and image data subjected to decoding and image processing responsive to a display instruction is stored in a cache irrespective of whether the image is a RAW image or a JPEG image.

In the second embodiment, image data having a low possibility of being reused is preferentially discarded. Compared to a JPEG image, a RAW image takes an extremely longer period of time for decoding and image processing. Therefore, when the RAW image is discarded, in the case of a cache miss, an adverse effect is larger. Therefore, a caching operation is controlled such that, if a RAW image is included in a cache memory, JPEG images are preferentially discarded while, if possible, preventing the RAW image from being discarded. Therefore, the total responsiveness can be increased.

In the configuration of the second embodiment, it is permitted to switch the currently displayed i-th image to only the i+1-th or the i−1-th image using the forward button 32 or the backward button 33. Accordingly, it can be considered that an image closer to the currently displayed image in the order of storage in the HDD 106 and/or the external storage medium has a higher possibility of being reused, while an image farther therefrom has a lower possibility of being reused.

Processing steps for discarding an unnecessary image based on the above-described conditions will be described with reference to a flowchart of FIG. 6.

First of all, in step S801, it is determined whether the number of already cached images is equal to M, which is the maximum number of images that the RAM 105 is able to cache. If the number of already cached images is smaller than M, the RAM 105 still has still free space. Therefore, since it is not necessary to discard any cached image, the process is immediately terminated. On the other hand, if the number of already cached images is equal to M, the process proceeds to step S802.

In step S802, it is determined whether both a RAW image and a JPEG image are contained together in the list 5. If it is determined that all of the images are JPEG images or RAW images, since there is little difference in the period of time required for decoding and image processing, the process proceeds to step S805. If, in step S802, it is determined that both of a RAW image and a JPEG image are contained together in the list 5, the process proceeds to step S803.

In step S803, it is determined whether both a RAW image and a JPEG image are contained together as cached image data. If it is determined that all of the images in cache are JPEG images or RAW images, since there is little difference in the period of time required for decoding and image processing, the process proceeds to step S805. If, in step S803, it is determined that both a RAW image and a JPEG image are contained together as cached image data, the process proceeds to step S804.

In step S804, cached image data of a JPEG image which is farthest from the currently displayed image is discarded, and the process is then terminated. A method for discarding a JPEG image will be described later.

In step S805, cached image data of an image which is farthest from the currently displayed image is discarded in accordance with the steps described with reference to FIG. 11, and the process is then terminated.

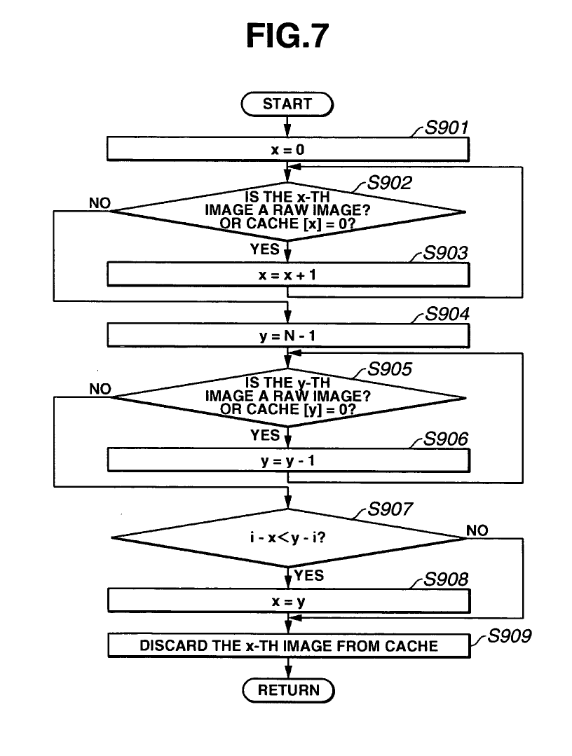

Next, in accordance with the flowchart shown in FIG. 7, a method for discarding the farthest JPEG image when JPEG images and RAW images are contained together in the cache memory, which is carried out in step S804 in FIG. 6, will be described.

In step S901, a parameter x is initialized to 0. In step S902, it is determined whether the x-th image is a RAW image, or the element CACHE[x] is 0. If either of the above conditions is met, the process proceeds to step S903, where the parameter x is incremented by one. Then, the process returns to step S902 and steps S902 and S903 are repeated until the determination in step S902 indicates “no.”

If the determination in step S902 indicates “no,” the process proceeds to step S904, where a parameter y is initialized with a value of N−1. N is the number of images stored in the HDD 106 and/or external storage medium mounted on the external storage device 107. Here, since the address holding area of the first image is defined as an element CACHE[0], the initialization value of y is set to N−1.

In step S905, it is determined whether the y-th image is a RAW image, or the element CACHE[y] is 0. If either of the above conditions is met, the process proceeds to S906, where the parameter y is decremented by one. Then, the process returns to step S905 and steps S905 and S906 are repeated until the determination in step S905 indicates “no.”

If the determination in step S905 indicates “no,” the process proceeds to step S907, where values i-x and y-i are compared with each other. If the value i-x is smaller than the value y-i (yes in step S907), the process proceeds to step S908, and if the value i-x is equal to or greater than the value y-i (no in step S907), the process proceeds to step S909.

In step S908, the parameter x is substituted with the parameter y. In step S909, the x-th image is discarded from the cache (memory is released), and the element CACHE[x] is substituted with a value of 0.

According to the above process, when the cache memory is full of images, in a case where both a JPEG image and a RAW image are contained together in the cached image data, image data of a JPEG image is preferentially discarded. In a case where both a JPEG image and a RAW image are not contained together, an image farthest from the currently displayed image is discarded. Accordingly, the total operation responsiveness can be improved.

In the above first and second embodiments, the case where both a JPEG image and a RAW image are contained together has been described. However, the invention is not limited to image data of such types. For example, the invention is applicable to image data of various types, such as lossless compression data, lossy compression data, and the like. In such a case, image data of a type which takes the longest period of time for processing, among the data types which can be processed by the image processing apparatus, may be substituted for a RAW image in the above first and second embodiments to be processed.

Further, the CPU 101 may determine the types of image data stored in the HDD 106 or the external storage medium, and may determine a type of image data which takes the longer period of time for image reading, decoding, and image processing based on the predetermined information. Alternatively, a caching operation may be controlled such that the user selects a type, and image data of any type other than that the selected type is not cached. Thus, a similar advantageous effect can be obtained.

Furthermore, in the above first and second embodiments, a caching operation may be configured such that a RAW image is set as a default type and, if necessary, the user can select another type to be cached using a pull-down menu.

On the other hand, in the above second embodiment, the tidy-up process for a cache memory in the case where two types, i.e., a RAW image and a JPEG image, are contained together has been described. However, the invention is not limited to the case where two types are contained together. Needless to say, the invention may be applied to the case where three or more types are contained together. In this case also, a caching operation may be controlled such that, if a RAW image is contained, the same processing steps as those shown in FIG. 6 are performed. That is, the operation for discarding image data from the cache is controlled based on the determination as to whether any RAW image is contained, or based on the determination as to whether the object image data is a RAW image or another type image. Alternatively, the caching operation may be configured such that, among various types, a type of image data which takes a longer period of time for decoding and image processing is given a higher order of priority. In this case, image data of a type with a lower priority of order is preferentially discarded. Thus, a similar advantageous effect can be obtained.

### Third Embodiment

Next, processing in an image processing apparatus configured as described above in accordance with a third embodiment of the invention will be described.

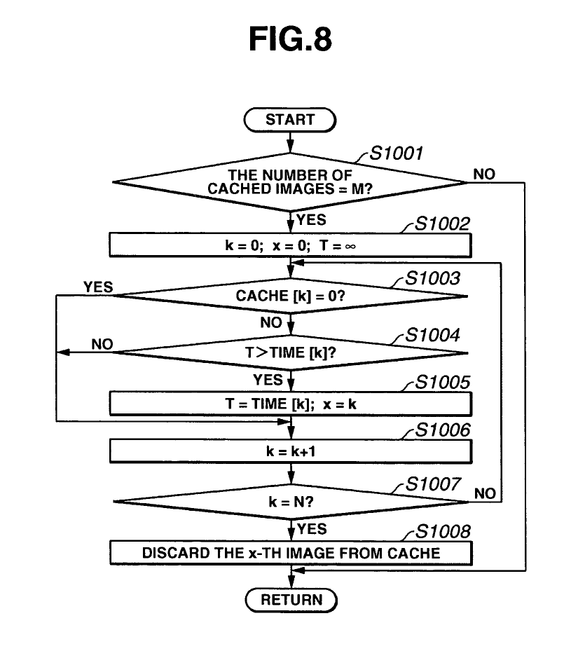

In the third embodiment also, since an image display method using the RAM 105 as a cache memory is similar to the method described with reference to FIG. 10, the description thereof is omitted. However, the basic tidy-up method for a cache memory carried out at step S406 in FIG. 10 is different from the method shown in FIG. 11. Therefore, with reference to a flow chart of FIG. 8, the tidy-up method for a cache memory in the third embodiment will be described below in detail.

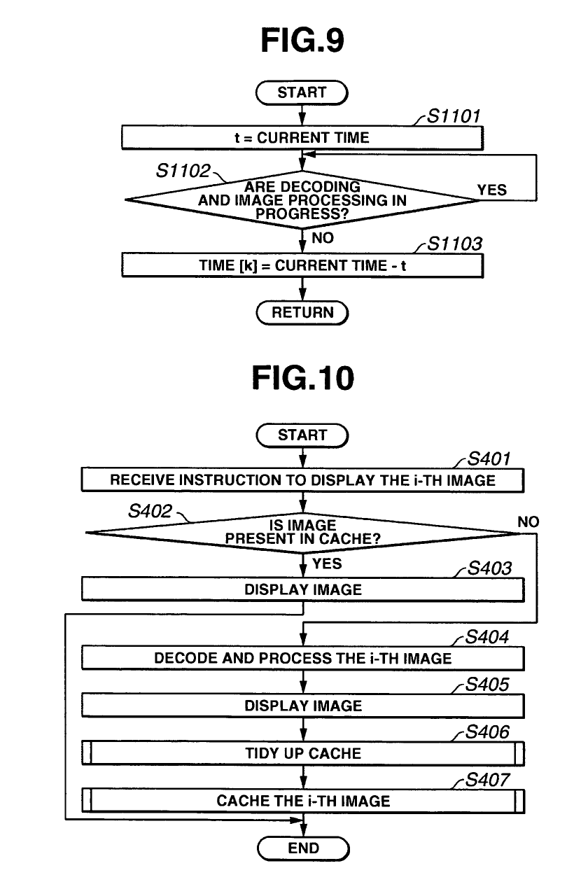

In the third embodiment, unlike the above-described first embodiment, processing for caching only a RAW image as described with reference to FIG. 5 is not performed. Instead, image data subjected to decoding and image processing responsive to a display instruction is stored in a cache irrespective of a RAW image or a JPEG image. In addition, a period of time taken to perform decoding and image processing is measured and stored. This time measurement process will be described later with reference to FIG. 9.

In the third embodiment, among images stored in the cache memory, an image that takes the shortest period of time to perform decoding and image processing is preferentially discarded from the cache memory. The reason of this is as follows. In the case of an image that takes a short period of time to perform decoding and image processing, even when the image is read out again from the HDD 106 and is subjected to decoding and image processing by the CPU 101, an adverse effect given to a responsiveness up to displaying thereof is relatively small. Particularly, the third embodiment is characterized in the following point. Since a determination is made based on a measurement result of the period of time, not only the type of data but also, for example, the difference in number of pixels can be handled.

The flow of discarding unnecessary images based on the above-described condition will be described below with reference to the flowchart of FIG. 8.

First of all, in step S1001, it is determined whether the number of images which have already been cached is equal to M, which is the maximum number of images that the RAM 105 is able to cache. If the number of already cached images is smaller than M, since the RAM 105 has still free space, it is not necessary to discard any cached image. Therefore, the process is immediately terminated. On the other hand, if the number of already cached images is equal to M, the process proceeds to step S1002.

In step S1002, a parameter k is initialized to 0, a parameter x is initialized to 0, and a parameter T is initialized to a sufficiently large value. In step S1003, it is determined whether the element CACHE[k] is 0. If the element CACHE[k] is 0, the process proceeds to step S1006. If the element CACHE[k] is not 0, the process proceeds to step S1004.

In step S1004, a comparison between the parameter T and a value TIME[k] is made. In the value TIME[k], although it will be described later in detail with reference to FIG. 9, a period of time taken to perform decoding and image processing of the k-th image is stored. If the parameter T is not greater than the value TIME[k], the process proceeds to step S1006. If the parameter T is greater than the value TIME[k], the process proceeds to step S1005. In step S1005, the parameter T is substituted with the value TIME[k], and the parameter x is substituted with the parameter k. Then, the process proceeds to step S1006.

In step S1006, the parameter k is incremented by one, and the process then proceeds to step S1007. In step S1007, the parameter k and a value N (N is the number of cached images) are compared with each other. If the parameter k and the value N are not equal to each other, the process returns to step S1003. Then, the steps from S1003 to S1007 are repeated with respect to the next value of the parameter k.

If the determination is completed with respect to all of the cached images, since the parameter k becomes equal to the value N, the determination in step S1007 becomes “yes.” The process then proceeds to step S1008. In step S1008, the x-th image is discarded from the cache (memory is released), and a value of 0 is substituted for the element CACHE[x].

According to the above process, if the cache memory is full of images, image data that takes the shortest period of time to perform decoding and image processing can be discarded.

Next, with reference to FIG. 9, a method of measuring a period of time taken to perform decoding and image processing will be described.

In step S1101, prior to decoding and image processing of an image, current time is stored in a parameter t. In step S1102, the process waits for completion of decoding and image processing of the image. If, in step S1102, it is determined that the decoding and image processing has been completed, the process proceeds to step S1103. In step S1103, current time is obtained again to calculate the difference between the current time and the value of the parameter t. Since this difference is a period of time taken to perform decoding and image processing of the image, it is stored in the value TIME[k]. By carrying out this processing in step S404 shown in FIG. 10, a period of time taken to perform decoding and image processing of an image can be stored in an array TIME, and the period of time can be used to specify image data to be discarded from the cache memory according to the above processing shown in FIG. 8.

As described above, according to the third embodiment, a period of time taken to perform decoding and image processing of an image is measured and stored. Then, when the cache memory is full of data, image data that takes the shortest period of time to perform decoding and image processing is discarded from the cache memory. Accordingly, the total operation responsiveness can be improved.

### Other Embodiments

In the above-described embodiments, as a limitation on the cache, the number of images storable in the cache is limited to a maximum of N. However, the invention is not limited to this configuration. For example, the amount of image data storable in the cache may be limited. Alternatively, instead of limiting the cache in advance, the number of images storable in the cache may be dynamically changed during the caching operation while observing free space of the RAM 105.

In addition, in the above-described first and second embodiments, it is presumed that, in the order of storage of image data on the HDD 106 and/or the external storage medium, the closer image to the currently displayed image is the more important, and the farther image is the less important. However, the invention is not limited to this presumption. For example, it may be presumed that an image of which a point of time of decoding and image processing is the later is the more important and an image of which a point of time of decoding and image processing is the earlier is the less important. Alternatively, it may be presumed that an image of which a point of time of the last display is the later is the more important, and an image of which a point of time of the last display is the earlier is the less important.

In the above-described embodiments, a process for switching images for the purpose of image display itself has been described. However, the invention may not aim at displaying images. It is needless to say that the invention may be adapted to be applicable to various processes including a switching operation of image display in which, for example, the user carries out arbitrary image processing to obtain the user's favorite images using an application program.

Furthermore, in the above-described embodiments, the case where images are displayed on the display unit 103 has been described. However, the invention is not limited to the case of image display. For example, the invention is applicable to a case where, when images are printed by a printer connected to the image processing apparatus via the communication unit 108 or a connector (not shown), image data which have been processed for printing is cached.

Furthermore, in the above-described embodiments, it is assumed that a computer system is used as the image processing apparatus. However, the invention is not limited to the computer system. For example, an image capture apparatus such as a digital camera or a digital video camera, a portable terminal with camera function, and a photo storage apparatus are available. That is, the invention is applicable to any apparatus which is capable of reading out image data recorded in different types from a storage medium, performing decoding and necessary image processing, and displaying images on a display apparatus.

Each embodiment can also be achieved by providing a system or apparatus with a storage medium (or a recording medium) that stores program code (software) for implementing the functions of the above-described embodiments, and causing a computer (or a CPU, a micro-processing unit (MPU) or the like) of the system or apparatus to read the program code from the storage medium and then to execute the program code. In this case, the program code itself read from the storage medium implements the functions of the embodiments. Furthermore, besides the program code read by the computer being executed to implement the functions of the above-described embodiments, the present invention includes an operating system (OS) or the like running on the computer performing an actual process in whole or in part according to instructions of the program code to implement the functions of the above-described embodiments. Examples of the storage medium storing the program code include a floppy disk, a hard disk, a ROM, a RAM, a magnetic tape, a non-volatile memory card, a CD-ROM, a compact disc-recordable (CD-R), a digital versatile disc (DVD), an optical disk, a magneto-optical disk (MO), etc. Also, a computer network such as a local area network (LAN) or a wide area network (WAN) can be employed to supply the program code.

Moreover, the present invention also includes a CPU or the like contained in a function expansion board inserted into the computer or in a function expansion unit connected to the computer, the function expansion board or the function expansion unit having a memory in which the program code read from the storage medium is written, the CPU or the like performing an actual process in whole or in part according to instructions of the program code to implement the functions of the above-described embodiments.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims priority from Japanese Patent Application No. 2004-250932 filed Aug. 30, 2004, which is hereby incorporated by reference herein in its entirety.

What is claimed is:

1. An image processing apparatus for reading out image data from a storage medium, performing predetermined processing on the image data, storing the processed image data in a storage unit and outputting the processed image data to an output unit, the image processing apparatus comprising:
a cache control unit configured to control a caching operation and an uncaching operation of the storage unit on processed image data;
a determination unit configured to determine whether the storage unit has available free space for storing image data;
a first detection unit configured to detect types of image data stored in the storage medium; and
a second detection unit configured to detect whether image data obtained by processing image data of a predetermined type is stored in the storage unit,
wherein, if the determination unit determines that the storage unit has no available free space and the second detection unit detects that processed image data of the predetermined type is stored in the storage unit, the cache control unit is configured to uncache processed image data of a type other than the predetermined type.

2. The image processing apparatus according to claim 1, wherein the predetermined type includes at least one data type of image.

3. The image processing apparatus according to claim 2, wherein the image processing apparatus further comprises a setting unit configured to set an order of priority for each of a plurality of data types of images, and
wherein the cache control unit is configured to uncache image data of a data type having a lower order of priority.

4. The image processing apparatus according to claim 1, wherein the predetermined type includes a data type processed with lossless compression.

5. The image processing apparatus according to claim 1, wherein the predetermined type includes a RAW data type.

6. The image processing apparatus according to claim 1, wherein the image processing apparatus further comprises a designation unit configured to designate the predetermined type.

7. An image processing apparatus for reading out image data from a storage medium, performing predetermined processing on the image data, storing the processed image data in a storage unit and outputting the processed image data to an output unit, the image processing apparatus comprising:
a cache control unit configured to control a caching operation and an uncaching operation of the storage unit on processed image data;
a determination unit configured to determine whether the storage unit has available free space for storing image data;
a time measurement unit configured to measure a period of time taken to perform the predetermined processing on the image data; and
a time storing unit configured to store the period of time measured by the time measurement unit in the storage unit,
wherein, if the determination unit determines that the storage unit has no available free space, the cache control unit is configured to uncache image data of which the measured period of time is the shortest.

8. An image processing apparatus for reading out image data from a storage medium, performing predetermined processing on the image data, storing the processed image data in a storage unit and outputting the processed image data to an output unit, the image processing apparatus comprising:
a cache control unit configured to control a caching operation and an uncaching operation of the storage unit on processed image data; and
a detection unit configured to detect data types of image data stored in the storage medium,
wherein, if the data types detected by the detection unit contain a predetermined data type, the cache control unit is configured to control the storage unit to cache only processed image data of the predetermined data type.

9. A control method for an image processing apparatus for reading out image data from a storage medium, performing predetermined processing on the image data, storing the processed image data in a storage unit and outputting the processed image data to an output unit, the control method comprising:
a cache control step of controlling a caching operation and an uncaching operation of the storage unit on processed image data;
a determination step of determining whether the storage unit has available free space for storing image data;
a first detection step of detecting types of image data stored in the storage medium; and
a second detection step of detecting whether image data obtained by processing image data of a predetermined type is stored in the storage unit,
wherein, if, in the determination step, it is determined that the storage unit has no available free space and, in the second detection step, it is detected that the processed image data of the predetermined type is stored in the storage unit, the cache control step includes a step of uncaching processed image data of a type other than the predetermined type.

10. The control method for an image processing apparatus according to claim 9, wherein the predetermined type includes at least one data type of image.

11. The control method for an image processing apparatus according to claim 10, wherein the control method further comprises a setting step of setting an order of priority for each of a plurality of data types of images, and
wherein the cache control step includes a step of uncaching image data of a data type having a lower order of priority.

12. The control method for an image processing apparatus according to claim 9, wherein the predetermined type includes a data type processed with lossless compression.

13. The control method for an image processing apparatus according to claim 9, wherein the predetermined type includes a RAW data type.

14. The control method for an image processing apparatus according to claim 9, wherein the control method further comprises a designation step of designating the predetermined type.

15. A program executable by an information processing apparatus and having program code for implementing the control method according to claim 9.

16. A storage medium readable by the information processing apparatus and having the program stored thereon according to claim 15.

17. A control method for an image processing apparatus for reading out image data from a storage medium, performing predetermined processing on the image data, storing the processed image data in a storage unit and outputting the processed image data to an output unit, the control method comprising:
a cache control step of controlling a caching operation and an uncaching operation of the storage unit on processed image data;
a determination step of determining whether the storage unit has available free space for storing image data;
a time measurement step of measuring a period of time taken to perform the predetermined processing on image data; and
a time storing step of storing the period of time measured by the time measurement step in the storage unit,
wherein, if, in the determination step, it is determined that the storage unit has no available free space, the cache control step includes a step of uncaching image data of which the measured period of time is the shortest.

18. A program executable by an information processing apparatus and having program code for implementing the control method according to claim 17.

19. A storage medium readable by the information processing apparatus and having the program stored thereon according to claim 18.

20. A control method for an image processing apparatus for reading out image data from a storage medium, performing predetermined processing on the image data, storing the processed image data in a storage unit and outputting the processed image data to an output unit, the control method comprising:
a cache control step of controlling a caching operation and an uncaching operation of the storage unit on processed image data; and
a detection step of detecting data types of image data stored in the storage medium,
wherein, if the data types detected by the detection step contain a predetermined data type, the cache control step includes a step of controlling the storage unit to cache only processed image data of the predetermined data type.

21. A program executable by an information processing apparatus and having program code for implementing the control method according to claim 20.

22. A storage medium readable by the information processing apparatus and having the program stored thereon according to claim 21.
